(19) United States
(12) Patent Application Publication
(10) Pub. No.: US 2015/0352787 A1
(43) Pub. Date: Dec. 10, 2015

(54) TWO-PART THERMOSETTING RESIN ADDITIVE MANUFACTURING SYSTEM

(71) Applicant: United Technologies Corporation, Hartford, CT (US)

(72) Inventors: Michael Paul Humbert, Manchester, CT (US); John P. Wesson, West Hartford, CT (US); Brian M. Welch, West Hartford, CT (US)

(21) Appl. No.: 14/729,655

(22) Filed: Jun. 3, 2015

Related U.S. Application Data
(60) Provisional application No. 62/009,525, filed on Jun. 9, 2014.

(51) Int. Cl. B29C 67/00

(52) U.S. Cl. CPC B29C 67/0085; B29C 67/007; B29K 2101/10

(57) ABSTRACT

An additive manufacturing system for forming a component on a layer-by-layer basis includes a first pump for pumping a first material and a second pump for pumping a second material. The additive manufacturing system further includes a mixer for receiving and mixing the first material and the second material to form a thermosetting resin, a nozzle fluidly connected to the mixer for extruding the thermosetting resin, and a motion control system connected to the nozzle for moving the nozzle in a predetermined pattern to form a layer of the component.

This application claims priority to U.S. Provisional Application No. 62/009,525, filed on Jun. 9, 2014, and entitled “TWO-PART THERMOSETTING RESIN ADDITIVE MANUFACTURING SYSTEM.”

### BACKGROUND

This invention relates generally to the field of additive manufacturing. In particular, the invention relates to a polymer additive manufacturing system employing two-part thermosetting resins.

Additive manufacturing refers to a category of manufacturing methods characterized by the fact that the finished part is created by a layer-wise construction of a plurality of thin layers of material identical in shape to equivalent planar cross sections of an exact digital model of the part. Additive manufacturing may involve applying material by a computer controlled process to a work stage and consolidating the material by an appropriate process to create one layer. The process is repeated up to several thousand times to arrive at the final component.

Polymer additive manufacturing is primarily limited to the use of thermoplastic materials. While polymer manufacturing techniques can produce parts with a wide array of properties, there are many limitations. Specifically, the use of parts made with these technologies is largely limited to temperatures under 120° C., with a few specialized materials extending the temperature window. Temperature limitations are even more pronounced when printing with flexible materials, whose structural properties tend to degrade at temperatures in the range of 60-80° C. Regardless of the printing temperature, the upper use temperature will be lower than the extrusion temperature, since softening of the materials will occur as the extrusion temperature is approached. High temperature thermoplastics compound the problem. While they may have high softening temperatures, the high melt viscosity and large temperature gradients result in large residual stresses remaining in the part. This increases the risk of warping, especially if the part is exposed to higher temperatures after fabrication.

### SUMMARY

An additive manufacturing system for forming a component on a layer-by-layer basis includes a first pump for pumping a first material and a second pump for pumping a second material. The additive manufacturing system further includes a mixer for receiving and mixing the first material and the second material to form a thermosetting resin, a nozzle fluidly connected to the mixer for extruding the thermosetting resin, and a motion control system connected to the nozzle for moving the nozzle in a predetermined pattern to form a layer of the component.

An additive manufacturing method of forming a component on a layer-by-layer basis includes pumping a first material from a first pump into a mixer, pumping a second material from a second pump into the mixer, and mixing the first material and the second material in the mixer to form a thermosetting resin. The method further includes extruding the thermosetting resin through a nozzle to deposit the thermosetting resin in a predetermined pattern to form a layer of the component.

### BRIEF DESCRIPTION OF THE DRAWINGS

FIG. 1 is a schematic diagram of an additive manufacturing system that builds parts using a two-component thermosetting resin.

FIG. 2 is a schematic diagram of an alternate embodiment additive manufacturing system.

FIG. 3 is a schematic diagram of an alternate embodiment additive manufacturing system.

FIG. 4 is a schematic diagram of an alternate embodiment additive manufacturing system.

### DETAILED DESCRIPTION

The additive manufacturing system disclosed allows layer-by-layer building of parts using a two-part thermosetting resin, which enables the creation of parts with improved strength and/or flexibility while also extending the range of temperatures in which the parts can operate. The additive manufacturing system uses a mixer to mix two parts of a two-part thermosetting resin on demand. The system extrudes the thermosetting resin through a nozzle before the resin cures. The additive manufacturing system allows for a consistent state of cure of the two-part thermosetting resin exiting the nozzle due to the ability to control the dwell time or residence time of the thermosetting resin in the mixer. The additive manufacturing system improves dimensional accuracy of parts built due to the consistent state of cure of the thermosetting resin. The additive manufacturing system may include large reservoirs of the two parts of a two-part thermosetting resin, as the materials do not react or begin to cure until the two parts are mixed.

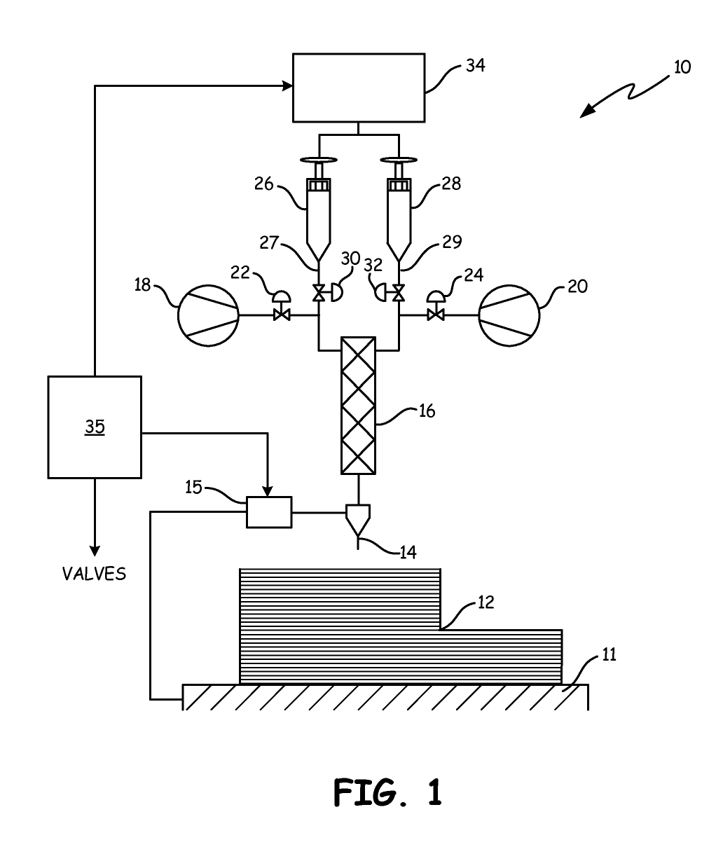

FIG. 1 is a schematic diagram of additive manufacturing system 10, which builds component 12 on platform or support surface 11. Additive manufacturing system 10 includes nozzle 14, motion control system 15, mixer 16, solvent supply 18, solvent supply 20, valve 22, valve 24, pump 26 with orifice 27, pump 28 with orifice 29, valve 30, valve 32, driving mechanism 34, and controller 35.

Additive manufacturing system 10 builds component 12 with a two-part thermosetting resin on a layer-by-layer basis. Pump 26 stores one part of a two-part thermosetting resin and pump 28 stores a second part of a two-part thermosetting resin. One part can be a resin material and the second part can be a hardener material. Driving mechanism 34 simultaneously drives pump 26 and pump 28 to pump the two parts of the thermosetting resin through orifice 27 and orifice 29 and into mixer 16. Driving mechanism 34 may include a first mechanism for driving pump 26 and a second mechanism for driving pump 28 such that pump 26 and pump 28 are driven at different rates in order to control the ratio of the two parts of the two-part thermosetting resin flowing into mixer 16. Orifice 27 and orifice 29 may have the same diameter. In an alternative embodiment, orifice 27 and orifice 29 may have different diameters in order to control the ratio of the two parts of the two-part thermosetting resin flowing into mixer 16. Pump 26 and pump 28 may be, for example, screw pumps, syringe pumps, or hydraulic pumping mechanisms. Mixer 16 mixes the two parts, and the two parts begin to react to form the two-part thermosetting resin. Mixer 16 may be a static mixer or a dynamic mixer.

The two-part thermosetting resin is subsequently extruded and deposited through nozzle 14 to form a layer of component 12. The diameter of nozzle 14 may be between 0.1 and 1.0 millimeters. A larger diameter of nozzle 14 allows component 12 to be built quickly while a smaller diameter allows for component 12 to be built with a higher resolution. Additive manufacturing system 10 extrudes and deposits the thermosetting resin through nozzle 14 before the two-part thermosetting resin cures. Due to the separation of the two parts of the two-part thermosetting resin, additive manufacturing system 10 controls the dwell time or residence time of the thermosetting resin in the mixer, allowing for a consistent state of cure of the two-part thermosetting resin exiting nozzle 14 throughout the additive manufacturing process. The process is repeated until component 12 is completed.

Controller 35 controls motion control system 15, driving mechanism 34, and valves 22, 24, 30 and 32. Controller 35 controls building of component 12 based on stored data, such as STL files, that define the shape of each layer to be formed. Motion control system 15 provides relative movement of nozzle 14 with respect to surface 11 in the x, y, and z directions to deposit the two-part thermosetting resin on surface 11 to form a layer of component 12. In one embodiment, motion control system 15 may move nozzle 14 in three dimensions. In an alternative embodiment, motion control system 15 may move surface 11 in the z direction while moving nozzle 14 in the x and y directions. In alternative embodiments, motion control system 15 may control movement of surface 11 and nozzle 14 in any combination of x, y, and z directions. Other alternative embodiments may include the use of up to five axes of motion control such that surface 11 can be rotated and the angle of nozzle 14 relative to the normal of surface 11 can be controlled either by movement of surface 11 or nozzle 14. Controller 35 may send signals to open and close valves 22, 24, 30, and 32 when necessary. In an alternative embodiment, valves 22, 24, 30, and 32 are controlled manually.

The two-part thermosetting resin may be an epoxy. In alternative embodiments, the two-part thermosetting resin may be an urethane or an acrylic. In alternative embodiments, one or both of the parts of the two-part resin may include one or more additives. The additives may be a filler, a catalyst, a viscosity modifier, a thickener, a high temperature crosslinker, or an accelerator. More specifically, the additives may be silica, calcium carbonate, iron oxide, clay (such as Garamite®), zinc oxide, a platinum-based catalyst, carbon black, graphite, graphene, graphene oxide, chopped glass fiber, iron-based ferromagnetic nanomaterial, nickel-based ferromagnetic material, or a ceramic, seen in Table 1 below.

TABLE 1

| Filler | Purpose |
|---|---|
| CaCO₃, Fe oxides, clays | Thixotropic (shear-thinning) |
| (Garamite ®) | thickener |
| ZnO | Thickener/high temperature crosslinker |
| | (for post-curing) |
| Carbon black, Graphite | Increased thermal and electrical |
| | conductivity |
| Graphene/graphene oxide | Increased strength, conductivity; may |
| | be thixotropic |
| Chopped glass fibers | Strength and thermal conductivity |
| Fe and Ni-based ferromagnetic | Localized heating through induction |
| nanomaterials | |
| Ceramics | Strength, electrical resistivity |

Solvent supply 18 and solvent supply 20 may be used to flush additive manufacturing system 10 or unclog additive manufacturing system 10 if additive manufacturing system 10 becomes clogged with material from pump 26 and pump 28. Valve 30 and valve 32 allow the two parts of the thermosetting resin to flow from pump 26 and pump 28 and may be closed to prevent material flow from pump 26 and pump 28. Valve 22 and valve 24 allow solvent from solvent supply 18 and solvent supply 20 to flow into additive manufacturing system to flush additive manufacturing system 10. Valve 22, valve 24, valve 30, and valve 32 may be check valves, manual valves, or solenoid valves.

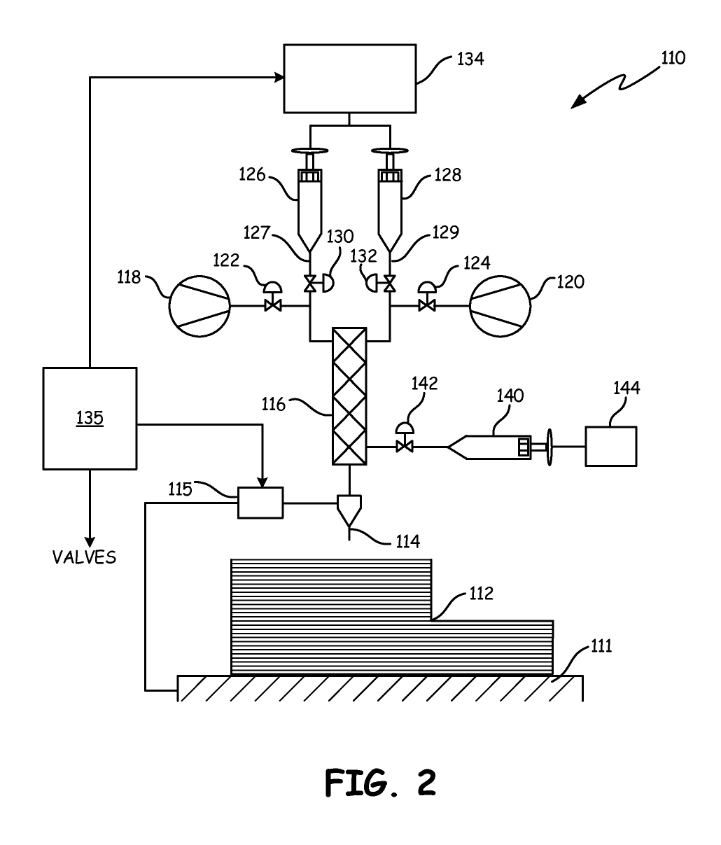

FIG. 2 is a schematic diagram of additive manufacturing system 110, an alternate embodiment of additive manufacturing system 10. Additive manufacturing system 110 builds component 112 on platform or support surface 111. Additive manufacturing system 110 includes nozzle 114, motion control system 115, mixer 116, solvent supply 118, solvent supply 120, valve 122, valve 124, pump 126 with orifice 127, pump 128 with orifice 129, valve 130, valve 132, driving mechanism 134, controller 135, pump 140, valve 142, and driving mechanism 144. Additive manufacturing system 110 is similar to additive manufacturing system 10, shown and described with respect to FIG. 1, although there are differences. For example, additive manufacturing system 110 includes pump 140, which stores an additive material. Driving mechanism 134 drives pump 140 to pump an additive material into mixer 116. In mixer 116, the additive material is mixed in with the two-part thermosetting resin. The additive material may be a filler, a catalyst, a viscosity modifier, a thickener, a high temperature crosslinker, or an accelerator, or any other additive material described with respect to FIG. 1. Pump 140 may be a screw pump, a syringe pump, or a hydraulic pumping mechanism. Valve 142 may prevent material from flowing into mixer 116 from pump 140.

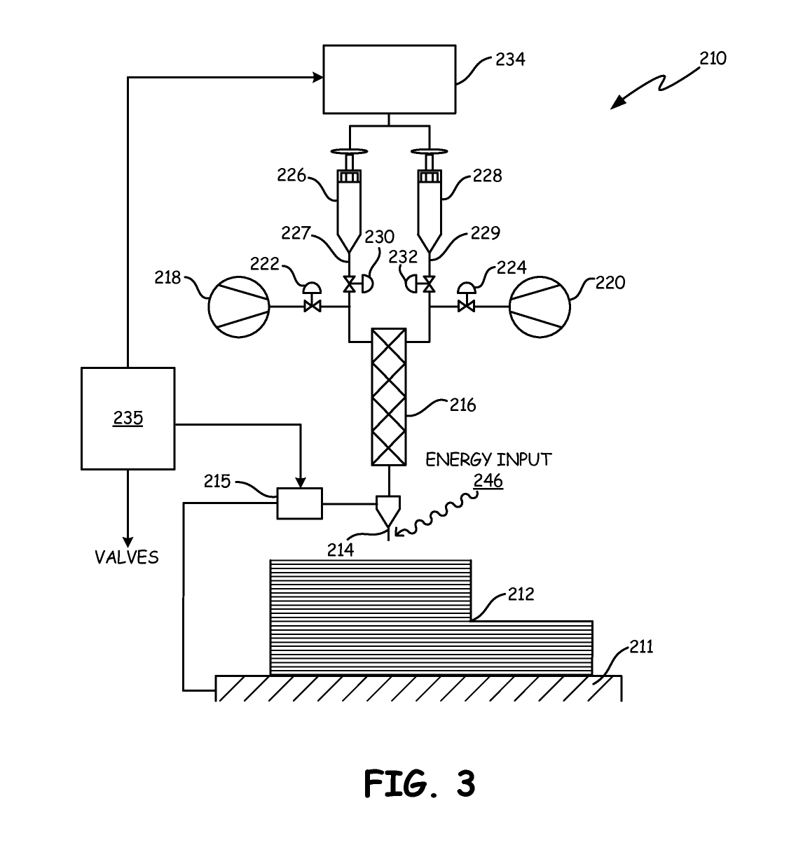

FIG. 3 is a schematic diagram of additive manufacturing system 210, an alternate embodiment of additive manufacturing system 10. Additive manufacturing system 210 builds component 212 on platform or support surface 211. Additive manufacturing system 210 includes nozzle 214, motion control system 215, mixer 216, solvent supply 218, solvent supply 220, valve 222, valve 224, pump 226 with orifice 227, pump 228 with orifice 229, valve 230, valve 232, driving mechanism 234, controller 235, and energy input 246. Additive manufacturing system 210 is similar to additive manufacturing system 10, shown and described with respect to FIG. 1, although there are differences. For example, additive manufacturing system 210 includes energy input 246. Energy input 246 may enhance the curing of the two-part thermosetting resin extruded and deposited from nozzle 214.

Energy input 246 may provide a stream of hot air directed at the two-part thermosetting resin leaving nozzle 214 in order to accelerate the rate at which the two-part thermosetting resin cures. In alternative embodiments, energy input 246 may be electromagnetic radiation such as microwave radiation, ultraviolet radiation, visible light, or infrared radiation. In alternate embodiments, the two-part thermosetting resin may include an additive that enhances local heat generation when exposed to energy input 246. The additive may be any material described with respect to FIG. 1. For example, magnetic materials such as ferrite could enable induction to rapidly heat the two-part thermosetting resin leaving nozzle 214. Carbon black could allow more efficient absorption of electromagnetic radiation.

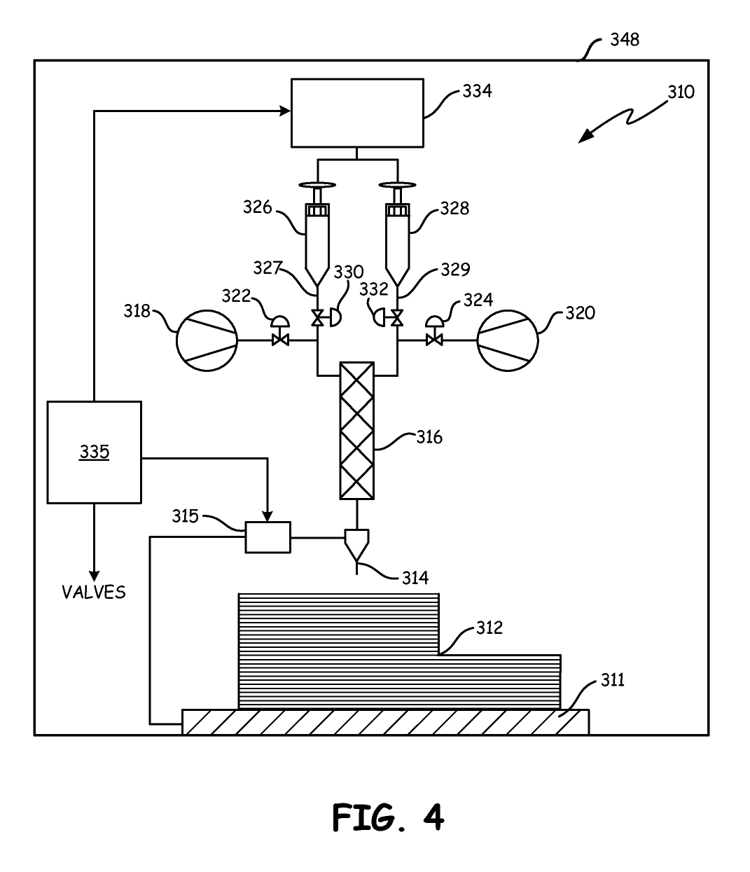

FIG. 4 is a schematic diagram additive manufacturing system 310, an alternate embodiment of additive manufacturing system 10. Additive manufacturing system 310 builds component 312 on platform or support surface 311. Additive manufacturing system 310 includes nozzle 314, motion control system 315, mixer 316, solvent supply 318, solvent supply 320, valve 322, valve 324, pump 326 with orifice 327, pump 328 with orifice 329, valve 330, valve 332, driving mechanism 334, and controller 335. Heated build chamber 348 surrounds additive manufacturing system 310. Additive manufacturing system 310 is similar to additive manufacturing system 10, shown and described with respect to FIG. 1, although there are differences. For example, heated build chamber 348 surrounds additive manufacturing system 310.

Heated build chamber 348 may accelerate the rate at which the two-part thermosetting resin cures. In order to prevent the two-part thermosetting resin from curing such that it clogs additive manufacturing system 310, mixer 316 may include a heat exchanger, a cooling manifold, or a heat shield, which prevents the two-part thermosetting resin from curing at an accelerated rate prior to deposition from nozzle 314. Nozzle 314 may also include a heat exchanger, a cooling manifold, or a heat shield, which prevents the two-part thermosetting resin from curing at an accelerated rate prior to deposition from nozzle 314.

### Discussion of Possible Embodiments

The following are non-exclusive descriptions of possible embodiments of the present invention.

An additive manufacturing system for forming a component on a layer-by-layer basis, among other possible things includes a first pump for pumping a first material and a second pump for pumping a second material. The additive manufacturing system further includes a mixer for receiving and mixing the first material and the second material to form a thermosetting resin, a nozzle fluidly connected to the mixer for extruding the thermosetting resin, and a motion control system connected to the nozzle for moving the nozzle in a predetermined pattern to form a layer of the component.

The additive manufacturing system of the preceding paragraph can optionally include, additionally and/or alternatively, any one or more of the following features, configurations and/or additional components:

A further embodiment of the foregoing additive manufacturing system, wherein the first material includes a resin and the second material includes a hardener.

A further embodiment of any of the foregoing additive manufacturing systems, wherein at least one of the first material and the second material further includes at least one of a filler, a catalyst, a viscosity modifier, a thickener, a high temperature crosslinker, and an accelerator.

A further embodiment of any of the foregoing additive manufacturing systems, wherein at least one of the first material and the second material further includes at least one of silica, calcium carbonate, iron oxide, clay, zinc oxide, a platinum-based catalyst, carbon black, graphite, graphene, graphene oxide, chopped glass fiber, iron-based ferromagnetic nanomaterial, nickel-based ferromagnetic material, and a ceramic.

A further embodiment of any of the foregoing additive manufacturing systems, wherein the thermosetting resin includes at least one of an epoxy, an urethane, and an acrylic.

A further embodiment of any of the foregoing additive manufacturing systems, further including a third pump for pumping a third material into the mixer.

A further embodiment of any of the foregoing additive manufacturing systems, wherein the first pump, the second pump, and the third pump include at least one of a syringe pump, a screw pump, or a hydraulic pumping mechanism.

A further embodiment of any of the foregoing additive manufacturing systems, wherein the third material includes at least one of a filler, a catalyst, a viscosity modifier, a thickener, a high temperature crosslinker, and an accelerator.

A further embodiment of any of the foregoing additive manufacturing systems, wherein the third material further includes at least one of silica, calcium carbonate, iron oxide, clay, zinc oxide, a platinum-based catalyst, carbon black, graphite, graphene, graphene oxide, chopped glass fiber, iron-based ferromagnetic nanomaterial, nickel-based ferromagnetic material, and a ceramic.

A further embodiment of any of the foregoing additive manufacturing systems, the system further including an energy input that imparts energy to the thermosetting resin extruded from the nozzle, wherein the energy input is at least one of a stream of hot air, a magnetic field, ultraviolet radiation, infrared radiation, microwave radiation, and visible light.

A further embodiment of any of the foregoing additive manufacturing systems, the system further including a driving mechanism for driving the first pump and the second pump, wherein the driving mechanism controls a ratio of the first material to the second material being pumped into the mixer.

A further embodiment of any of the foregoing additive manufacturing systems, wherein the driving mechanism includes a first mechanism for driving the first pump and a second mechanism for driving the second pump.

A further embodiment of any of the foregoing additive manufacturing systems, wherein the first pump defines a first orifice with a first diameter, the first orifice located between the first pump and the mixer; wherein the second pump defines a second orifice with a second diameter, the second orifice located between the second pump and the mixer; and wherein relative sizes of the first diameter and the second diameter control a ratio of the first material to the second material being pumped into the mixer.

A further embodiment of any of the foregoing additive manufacturing systems, the system further including a heated chamber enclosing the additive manufacturing system.

A further embodiment of any of the foregoing additive manufacturing systems, wherein the mixer includes at least one of a heat exchanger, a cooling manifold, and a heat shield.

An additive manufacturing method of forming a component on a layer-by-layer basis, among other possible things includes pumping a first material from a first pump into a mixer, pumping a second material from a second pump into the mixer, and mixing the first material and the second material in the mixer to form a thermosetting resin. The method further includes extruding the thermosetting resin through a nozzle to deposit the thermosetting resin in a predetermined pattern to form a layer of the component.

The additive manufacturing method of the preceding paragraph can optionally include, additionally and/or alternatively, any one or more of the following features, configurations and/or additional components:

A further embodiment of the foregoing additive manufacturing method, wherein the thermosetting resin has a residence time in the mixer such that the thermosetting resin hardens after the thermosetting resin is deposited.

A further embodiment of any of the foregoing additive manufacturing methods, the method further including inputting energy to the thermosetting resin during or after extrusion of the thermosetting resin from the nozzle, wherein the energy is at least one of a stream of hot air, a magnetic field, ultraviolet radiation, infrared radiation, microwave radiation, and visible light.

A further embodiment of any of the foregoing additive manufacturing methods, the method further including driving the first pump and the second pump with a driving mechanism and controlling a ratio of the first material to the second material being pumped into the mixer with the driving mechanism.

A further embodiment of any of the foregoing additive manufacturing methods, the method further including heating the thermosetting resin extruded from the nozzle and preventing heating of the mixer with at least one of a heat exchanger, a cooling manifold, and a heat shield.

Although the present invention has been described with reference to preferred embodiments, workers skilled in the art will recognize that changes may be made in form and detail without departing from the spirit and scope of the invention.

1. An additive manufacturing system for forming a component on a layer-by-layer basis, the system comprising:
a first pump for pumping a first material;
a second pump for pumping a second material;
a mixer for receiving and mixing the first material and the second material to form a thermosetting resin;
a nozzle fluidly connected to the mixer for extruding the thermosetting resin; and
a motion control system connected to the nozzle for moving the nozzle in a predetermined pattern to form a layer of the component.

2. The system of claim 1, wherein the first material comprises a resin and the second material comprises a hardener.

3. The system of claim 2, wherein at least one of the first material and the second material further comprises at least one of a filler, a catalyst, a viscosity modifier, a thickener, a high temperature crosslinker, and an accelerator.

4. The system of claim 2, wherein at least one of the first material and the second material further comprises at least one of silica, calcium carbonate, iron oxide, clay, zinc oxide, a platinum-based catalyst, carbon black, graphite, graphene, graphene oxide, chopped glass fiber, iron-based ferromagnetic nanomaterial, nickel-based ferromagnetic material, and a ceramic.

5. The system of claim 1, wherein the thermosetting resin comprises at least one of an epoxy, an urethane, and an acrylic.

6. The system of claim 1, and further comprising a third pump for pumping a third material into the mixer.

7. The system of claim 6, wherein the first pump, the second pump, and the third pump comprise at least one of a syringe pump, a screw pump, or a hydraulic pumping mechanism.

8. The system of claim 6, wherein the third material comprises at least one of a filler, a catalyst, a viscosity modifier, a thickener, a high temperature crosslinker, and an accelerator.

9. The system of claim 6, wherein the third material further comprises at least one of silica, calcium carbonate, iron oxide, clay, zinc oxide, a platinum-based catalyst, carbon black, graphite, graphene, graphene oxide, chopped glass fiber, iron-based ferromagnetic nanomaterial, nickel-based ferromagnetic material, and a ceramic.

10. The system of claim 1, and further comprising:
an energy input that imparts energy to the thermosetting resin extruded from the nozzle;
wherein the energy input is at least one of a stream of hot air, a magnetic field, ultraviolet radiation, infrared radiation, microwave radiation, and visible light.

11. The system of claim 1, and further comprising:
a driving mechanism for driving the first pump and the second pump;
wherein the driving mechanism controls a ratio of the first material to the second material being pumped into the mixer.

12. The system of claim 11, wherein the driving mechanism comprises a first mechanism for driving the first pump and a second mechanism for driving the second pump.

13. The system of claim 1,
wherein the first pump defines a first orifice with a first diameter, the first orifice located between the first pump and the mixer;
wherein the second pump defines a second orifice with a second diameter, the second orifice located between the second pump and the mixer; and
wherein relative sizes of the first diameter and the second diameter control a ratio of the first material to the second material being pumped into the mixer.

14. The system of claim 1, and further comprising a heated chamber enclosing the additive manufacturing system.

15. The system of claim 14, wherein the mixer comprises at least one of a heat exchanger, a cooling manifold, and a heat shield.

16. An additive manufacturing method of forming a component on a layer-by-layer basis, the method comprising:
pumping a first material from a first pump into a mixer;
pumping a second material from a second pump into the mixer;
mixing the first material and the second material in the mixer to form a thermosetting resin; and
extruding the thermosetting resin through a nozzle to deposit the thermosetting resin in a predetermined pattern to form a layer of the component.

17. The method of claim 16, wherein the thermosetting resin has a residence time in the mixer such that the thermosetting resin hardens after the thermosetting resin is deposited.

18. The method of claim 16, and further comprising:
inputting energy to the thermosetting resin during or after extrusion of the thermosetting resin from the nozzle;
wherein the energy is at least one of a stream of hot air, a magnetic field, ultraviolet radiation, infrared radiation, microwave radiation, and visible light.

19. The method of claim 16, and further comprising:
driving the first pump and the second pump with a driving mechanism; and
controlling a ratio of the first material to the second material being pumped into the mixer with the driving mechanism.

20. The method of claim 16, and further comprising:
heating the thermosetting resin extruded from the nozzle; and
preventing heating of the mixer with at least one of a heat exchanger, a cooling manifold, and a heat shield.
